(19) United States
(12) Patent Application Publication
(10) Pub. No.: US 2004/0241058 A1
(43) Pub. Date: Dec. 2, 2004

(54) Production and processing plant with a rigid pipe portion curving in three dimensions

(76) Inventors: Colin G Caro, London (GB); David D.A. Piesol, Kent (GB); William Tallis, Leamington (GB)

Correspondence Address: James P Zeller, Marshall Gerstein & Borun, 6300 Sears Tower, 233 South Wacker Drive, Chicago, IL, 60606-6357, US

(21) Appl. No.: 10/478,115

(22) PCT Filed: May 17, 2002
(86) PCT No.: PCT/GB02/02319

(30) Foreign Application Priority Data
May 17, 2001 (GB) 0112066.6
Apr. 12, 2002 (GB) 0208496.0

(51) Int. Cl. B01J 8/00; B01J 10/00

(52) U.S. Cl. 422/188; 422/129; 422/234

(57) ABSTRACT

Production and processing plant in particular for the processing of food or hydrocarbons and the production of pharmaceuticals, including pipework for transferring fluids from one part of the plant to another, the pipework including at least one substantially rigid pipe having at least one section with a centreline curving, preferably substantially continuously, in three dimensions.

The present invention relates to processing and production plant, and more particularly, to hydrocarbon, food and pharmaceutical production and/or processing plant, and pipework for such plant.

Food processing plant such as sugar refineries, meat processing plants, vegetable processing plants and canneries, and pharmaceutical production plants, normally consist of a very large number of individual processing units (heaters, separators, filters and so on) and associated units (storage tanks, pumps, compressors and the like). Similarly, hydrocarbon processing plant such as oil refineries include processing units (such as distillation columns, crackers, reformers and so on) and associated units, and can extend over very large areas.

It is necessary for the various units to be linked by pipework to allow fluid communication between them. Such pipework systems can be of considerable complexity, and as it will not normally be possible to have a straight pipe extending between the units, the pipework will generally consist of a number of lengths of straight pipe connected by bends, such as elbow bends and T-junctions.

Pipe fittings such as elbow bends normally cause head loss in the fluid flowing in the pipe. The head loss caused by fittings can be reduced by modification of the fittings; for example, the sweep of an elbow bend can be increased. However, there is still the problem that the mere presence of fittings of this type will contribute to head loss. In addition, in the environment of a processing or production plant such as a food processing plant, hydrocarbon processing plant or pharmaceutical production plant, it may not be possible to use elbow bends with a large sweep.

This head loss can be significant in the context of food or hydrocarbon processing plant and pharmaceutical production plant, where the situation of large mass flow rates at low pressures is encountered. One particular situation where flow of this type arises, in the context of hydrocarbon processing plant, is in the pipework between a distillation column of an ethylene plant front end (often referred to as a primary fractionator or primary separator) and a compressor (commonly referred to as a cracked gas compressor).

Further, particularly in the context of food processing, it is desirable to ensure that the residence time of material flowing through a pipe is kept as low as possible.

In addition, it is desirable to avoid stagnation and flow separation, and, accordingly, long residence times, if possible. This is particularly important if batch processing is carried out, as flow separation can lead to a fluid being contaminated by residues of the previous fluid. In order to ameliorate contamination of this type, it is generally necessary to wash out the pipes using either a cleaning fluid or a quantity of the second fluid which is subsequently discarded. Such a washing-out process is time-consuming, and may also be wasteful.

According to a first aspect of the invention, there is provided a processing or production plant, including pipework for transferring fluids from one part of the plant to another, wherein the pipework comprises at least one substantially rigid pipe having at least one section with a centreline curving in three dimensions.

In a normal elbow bend, in which the centreline of the pipe curves in two dimensions, the pressure at the inside of the curve is reduced in comparison to that at the outside of the curve. There is a resultant tendency for flow to separate from the inner wall of the curve, leading to energy losses caused by eddying turbulence. The flow separation may also result in cavitation at the inner wall, which can damage the pipe and reduce its useful working life.

However, in a tubular portion the centreline of which curves in three dimensions, swirl flow tends to develop. Under these circumstances, the axial velocity profile of the flow across the tubular portion becomes more uniform or “blunter”, with the speed of flow on the outside of the centreline of the curve being less than it would be in similar flow in a two-dimensional curved pipe, and the speed inside of the centreline being greater. Thus, the near wall velocity (wall shear) profile around the tubular portion tends to be circumferentially more uniform with its non-planar geometry than it would be with planar geometry (in a normal elbow bend). Since the velocity profile of the flow is more uniform, there is a reduced tendency for separation to occur at the inner wall of the curve, and this leads to reduced energy losses caused by eddying turbulence, and reduced risk of cavitation. If there is less cavitation, there will be less damage to the pipework, and thus less need to replace damaged pipes. It will be appreciated that the downtime involved in replacing a damaged pipe can have significant economic implications.

The three-dimensional curvature of the pipe advantageously increases the mixing of the fluid travelling through the pipe across its cross-section. The out of plane curvature may also advantageously suppress separation and instability (turbulence) within the pipe.

A further major benefit from the more uniform axial velocity profile is that there is a significantly reduced tendency for fouling on the inside of the bend, which can, for example, result from the separation of suspended particles from the fluid flowing in the bend. Such separation can occur in a normal planar elbow bend as a result of the flow separation mentioned above. Separated material of this type may cause contamination if it is degraded over time, or if the pipework is used for multiple fluids. An example of the latter case is in the pipework to a pharmaceutical batch reactor, which is used for more than one type of reaction or to prepare different strengths of the same material. It will be appreciated that any such degradation should be avoided, particularly in the contexts of food processing and pharmaceutical production.

The more uniform concentration profile is also important in maintaining concentration profiles and minimizing mixing if the same pipework is used to transport different materials; for example, filling a batch reactor with ingredients. The axial dispersion of batches may also be reduced and the peak concentration is achieved much earlier than for conventional arrangements. These features are particularly beneficial if the batch sizes are small.

In addition, the reduced risk of flow separation helps reduce the chance of contamination in batch processing. Accordingly, the time required to wash out the system may be at least reduced along with the quantity of fluid required to perform the washing-out.

The reduction of the pressure drop which can be achieved using pipes having a centreline curving in three dimensions rather than elbow bends can also be of significant importance with regard to food and hydrocarbon processing and pharmaceutical production, and in particular in situations where there is a high mass flow rate at a low pressure as described above.

In addition, the use of pipework curving in three dimensions, and the more uniform velocity distribution and improved mixing in the cross-section of the pipe which results, is also important in improving the uniformity of heat transfer. This is particularly relevant to heat sensitive materials, as are often found in the food processing and pharmaceutical production industries.

A still further advantage of the use of a pipe having a centreline curving in three dimensions is that the residence time for the material flowing in the pipe is reduced. This is a result of the more uniform axial velocity profile. In a pipe with a planar bend, flow is much faster outside the centreline of the curve than on the inside, and so material on the inside of the curve of the pipe (particularly in laminar flow) tends to have a relatively long residence time. The more uniform axial velocity flow profile obtained by using a pipe having a centreline curving in three dimensions reduces the residence time, particularly for material near the pipe wall on the inside of the curve.

In a preferred form, the plant includes at least one processing unit, wherein the pipework leading to or from the processing unit comprises at least one substantially rigid pipe, having at least one section with a centreline curving in three dimensions.

In a particularly preferred form, the processing unit may for example be a distillation column, and the pipework may be for transferring the distiled components to downstream sites, in particular for transferring the overhead gas stream to a cracked gas compressor. The gases in an overhead stream are normally at a pressure of less than 1 bar (100 kPa) gauge, and this pressure can be as low as 5 psi (35 kPa) gauge at the point of entry into the compressor. The compressor is used to compress the gases to a pressure of around 400 bar (40 MPa), and is normally a multi-stage compressor with a power requirement of several thousand horsepower (several megawatts). Further, there is a high mass flow rate (which may be in the order of 3000 tonnes per day), and thus it will be seen that this is a high mass flow rate/low pressure situation as discussed above. If the gases can enter the compressor at a higher pressure, then the power required by the compressor can be reduced, or the throughput increased for the same power. If the entry pressure can be increased enough (in other words, if the pressure drop in the pipework can be reduced sufficiently), it may even be possible to use a compressor with fewer stages. Use in this situation of pipes having a centreline curving in three dimensions (rather than straight pipes connected by elbow bends) allows the pressure drop to be reduced, and thus the entry pressure to be increased. The increased pressure, and thus the increased throughput, reduced power requirement and/or reduction in the number of stages allows significant reductions in the operating costs of the plant to be made.

Pipes having centrelines curving in three dimensions can also be used to connect different parts of a processing unit, such as in the reflux and/or reboiler pipework of a distillation column.

The plant may also comprise at least one vacuum source, wherein the pipework connecting the vacuum source to the remainder of the plant comprises at least one substantially rigid pipe, having at least one section with a centreline curving in three dimensions.

The reduction of pressure drop is of significant importance with regard to the pipework used to connect a vacuum source to a vacuum distillation column or other vacuum equipment. A vacuum distillation column is generally similar to an ordinary distillation column, but with the additional feature that the pressure in the column is reduced to below atmospheric by applying a vacuum source to the top of the column; this reduces the boiling temperatures of the fluids and can reduce the risk of thermal degradation during distillation. In a vacuum distillation column, the vacuum source must be connected to the top of the column by means of pipework. Vacuum sources are generally relatively heavy, and it is desirable for them to be located at ground level, both for safety reasons and to facilitate maintenance.

However, distillation columns can be tall, and therefore the pipework connecting the vacuum source to the top of the distillation column may be of considerable length. As it may not be possible for the vacuum source to be positioned ideally with respect to the distillation column, prior art pipework connecting the vacuum source to the top of the distillation column generally consists of a number of lengths of straight pipe connected by bends such as elbow bends. As discussed above, these create a pressure drop which reduces the efficiency of the vacuum distillation column.

The use of pipes with a centreline curving in three dimensions to connect the vacuum source to the vacuum distillation column gives a lower pressure drop in the pipework, and so allows a less powerful vacuum creating device to be used, or allows a vacuum source to draw a higher vacuum. This can help in reducing the running costs of the plant.

Preferably, the centreline of the pipe curves substantially continuously in three dimensions.

Although the present invention has been described with reference to food, hydrocarbon and pharmaceutical plants, it may also find service in a range of other applications. Indeed, any application requiring different fluids to be transferred through a rigid pipe may benefit from the lower pressure drop, from the more uniform residence time and from the reduced problems of relatively stagnant flow and material settling out in the case of fluids containing suspended solids. Fluids being transferred through rigid pipes in batches may benefit from reduced contamination between batches as a result of the pipe structure.

These benefits are relevant to a wide range of industrial processes which involve conveying fluids through rigid pipes. These include oil, gas and other hydrocarbon processes, chemical, water, air and other gas processes, in addition to the wide range of food and pharmaceutical processes described above. Additionally, fluids are often used in the control systems of processes, and the advantages discussed above may be useful for fluids in such control systems.

1. A processing or production plant, including pipework for transferring fluid from one part of the plant to another, wherein the pipework comprises at least one substantially rigid pipe having at least one section with a centerline curving in three dimensions.

2. A plant as claimed in claim 1, including at least one processing unit, wherein the pipework leading to or from the processing unit comprises at least one substantially rigid pipe, having at least one section with a centerline curving in three dimensions.

3. A plant as claimed in claim 1, comprising at least one vacuum source, wherein the pipework connecting the vacuum source to the remainder of the plant comprises at least one substantially rigid pipe, having at least one section with a centerline curving in three dimensions.

4. A plant as claimed in claim 1, wherein the centerline of the pipe curves substantially continuously in three dimensions.

5. Pipework for use in a plant as claimed in claim 1, the pipework comprising at least one substantially rigid pipe having at least one section with a centerline curving in three dimensions.
